(19) United States
(12) Patent Application Publication
(10) Pub. No.: US 2022/0041262 A1
(43) Pub. Date: Feb. 10, 2022

(54) MIXED LIFTING GASES FOR HIGH-ALTITUDE BALLOONS

(71) Applicants: Massachusetts Institute of Technology, Cambridge, MA (US); LTAG Systems, Bow, NH (US)

(72) Inventors: Alexander H. Slocum, Bow, NH (US); Jonathan Slocum, Bow, NH (US); George Ni, Cambridge, MA (US); Erik Limpaecher, Concord, MA (US); Eric Morgan, Bolton, MA (US)

(73) Assignees: Massachusetts Institute of Technology, Cambridge, MA (US); LTAG Systems, Bow, NH (US)

(21) Appl. No.: 17/342,789

(22) Filed: Jun. 9, 2021

Related U.S. Application Data
(60) Provisional application No. 63/063,849, filed on Aug. 10, 2020.

(51) Int. Cl. B64B 1/44; B64B 1/62; C01B 3/10; B64B 1/64

(52) U.S. Cl. CPC B64B 1/44; B64B 1/64; C01B 3/10; B64B 1/62

(57) ABSTRACT

Systems and methods for producing mixed lifting gases (e.g., hydrogen gas and steam) for filling balloons are described. In some embodiments, controlling an altitude of a balloon includes combining a reactant and water to produce hydrogen gas and steam, and flowing the hydrogen gas and steam into the balloon to increase a buoyancy of the balloon.

### CROSS-REFERENCE TO RELATED APPLICATIONS

This application claims priority under 35 U.S.C. § 119(e) to U.S. provisional application Ser. No. 63/063,849, filed Aug. 10, 2020, the disclosure of which is incorporated herein by reference in its entirety.

### GOVERNMENT LICENSE RIGHTS

This invention was made with Government support under Contract No. FA8702-15-D-0001 awarded by the U.S. Air Force. The Government has certain rights in the invention.

### FIELD

Disclosed embodiments are related to systems and methods of producing hydrogen gas and steam for filling balloons.

### BACKGROUND

High-altitude balloons, also called near-space balloons, often operate at altitudes above 80,000 feet, and sometimes operate at altitudes in excess of 100,000 feet. The balloons are filled with a gas that is less dense than air, such as helium or hydrogen, which produces a buoyant force that is capable of lifting a payload. A high-altitude balloon system controls its altitude by manipulating forces associated with buoyancy and weight. To decrease altitude, gas can be vented from the balloon, decreasing the overall buoyancy of the system. To increase altitude, ballast can be dropped from the balloon, decreasing the overall weight of the system.

### SUMMARY

In one embodiment, a method of filling a balloon includes: combining a reactant and water to produce hydrogen gas and steam; and flowing the hydrogen gas and the steam into the balloon to increase a buoyancy of the balloon.

In one embodiment, a system for producing hydrogen gas and steam includes: a reactor chamber; and a water reservoir operatively coupled to the reactor chamber. The reactor chamber is configured to contain a reactant. A water feeder is configured to selectively provide water from the water reservoir to the reactor chamber, and the water reservoir is configured to provide a ratio of the water and the reactant in the reactor chamber to generate hydrogen gas and steam.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of one embodiment of a balloon system;

FIG. 2 is a flow diagram of one embodiment of a method for controlling an altitude of a balloon system; and

FIG. 3 is a flow diagram of one embodiment of a method for inflating a balloon using a system configured to operate on the ground.

### DETAILED DESCRIPTION

Currently, there is a lack of alternative lifting gases that can be used to provide buoyant forces for lifting balloons. For instance, hydrogen gases produced from chemical reactions have been used to produce lifting gas. However, the amount of hydrogen gases produced from a given chemical reaction may be limited, and certain scenarios may call for a rapid production of a large quantity of lifting gases at a fast rate for lifting balloons. Thus, the inventors have recognized that there is a need for methods or systems for producing alternative lifting gases.

In view of the above, the Inventors have recognized the need of a chemical reaction in a balloon system that may be capable of producing mixed lifting gases, such as a mixture of hydrogen gas and steam. Steam may provide an additional lifting force and increase both the amount and rate of generation for lifting balloons. Additionally, the inclusion of steam in a mixture with hydrogen may reduce the flammability of the hydrogen gases which may also help to improve the safety of such systems. The production of mixed hydrogen gas and steam may also be more cost effective compared to producing pure hydrogen gases. Compared to conventional balloon systems that utilize dry hydrogen gas and are purposely designed to selectively remove the unwanted steam and/or condensates, a balloon system utilizing steam as a lifting gas may prove to be simple in construction, more economical, and more efficient.

Without wishing to be bound by theory, hydrogen gas and steam may be produced by combining a reactant with water. For instance, in some embodiments, the reactant may be aluminum, sodium, magnesium, zinc, boron, beryllium, other metallic compounds that are reactive with water to form hydrogen, and alloys thereof. For example, using aluminum or an alloy of aluminum as the reactant, hydrogen may be produced according to the reaction:

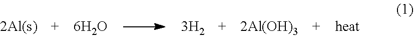

The Inventors have appreciated that this chemical reaction may produce both hydrogen gas, heat, and a waste product (in this case, aluminum hydroxide). Additionally, in some embodiments, steam may be generated from the resultant heat of reaction. Certain embodiments of the disclosure are related to systems and methods of producing both hydrogen gas and steam in the aforementioned chemical reaction. As such, both the hydrogen gas and steam may be used to increase the buoyant force acting on a balloon. Additionally, after condensing, the steam may be used as a ballast for additional altitude control of a balloon. For instance, via a combination of conductive and/or convective heat transfer through the balloon itself and/or another appropriate heat transfer structure, at least a portion of the steam inside a balloon may condense into water condensate. The water condensate may be used as a ballast and dropped to decrease the weight of the balloon system. Similarly, a waste product (e.g., aluminum hydroxide) associated with the aforementioned reaction may also be used as a ballast and dropped to decrease the weight of the balloon system. As such, a system that employs this chemical reaction and/or another similar chemical reaction may enable increased system lift.

In some embodiments, a method of filling and/or controlling an altitude of a balloon may comprise combining a reactant and water to produce hydrogen gas and steam. In some such embodiments, both the amount and rate of steam generation may be optimized by optimizing parameters such as water to reactant ratio, surface contact between water and reactant (e.g., reactant shape and size), as well as the composition of the reactant to produce a desired amount of hydrogen and steam at a desired rate. For example, in some embodiments, the water and the reactant may be combined at a particularly beneficial ratio that gives rise to steam generation. In some cases, optimizing steam generation may be associated with minimizing water to reactant ratio, such that a portion of the water may vaporize during the reaction to form steam as opposed to merely raising a temperature of a bulk volume of water without vaporizing. For instance, in some embodiments, the water and the reactant may be combined at a water to reactant mass ratio (i.e., weight ratio) of greater than or equal to 2:1, greater than or equal to 4:1, greater than or equal to 5:1, greater than or equal to 8:1, greater than or equal to 10:1, greater than or equal to 12:1, greater than or equal to 16:1, greater than or equal to 20:1, greater than or equal to 24:1, greater than or equal to 28:1, greater than or equal to 32:1, or greater than or equal to 36:1. In some embodiments, the water and the reactant may be combined at a water to reactant mass ratio of less than or equal to 40:1, less than or equal to 35:1, less than or equal to 30:1, less than or equal to 28:1, less than or equal to 25:1, less than or equal to 20:1, less than or equal to 15:1, less than or equal to 10:1, less than or equal to 5:1, less than or equal to 3:1. Combinations are also possible (e.g., greater than or equal to 2:1 and less than or equal to 28:1, or greater than or equal to 5:1 and less than or equal to 40:1). Other ranges may be possible. It should be noted that above a certain water to reactant ratio (e.g., 40:1), the heat of reaction may no longer be enough to vaporize a majority of the water and steam may no longer be produced.

In some embodiments, the balloon may be made from any suitable material. For instance, the material may be capable of withstanding a temperature and/or pressure associated with the steam and hydrogen gas in the balloon. For instance, the material may be any suitable polymers or elastic polymers. In some instances, the polymer may be hydrophobic polymers. Non-limiting examples of the material include uncured latex, polyamide, polydimethylsiloxane (PDMS), etc. In some instance, a material that is capable of continual operation at temperatures of up to about 100° C. may be chosen.

As mentioned, steam generation may be affected by the composition of the reactant. In certain embodiments, hydrogen gas and steam are produced by exposing a composition containing a reactant (e.g., aluminum) to water. In some such embodiments, the rate and amount of hydrogen gas and steam produced from reaction (1) can be controlled by modifying the type and concentration of certain elements (e.g., reactant) within the composition. In some such embodiments, the reactant may include aluminum, as described above with relation to Eq. (1). However, other metals may also be used depending on the particular embodiment. Non-limiting examples of reactive metals that may be used are aluminum, lithium, sodium, magnesium, zinc, boron, beryllium, and/or any other reactive metal capable of reacting with water to generate hydrogen and steam.

In some embodiments, the composition further comprises an activating composition that is permeated into the grain boundaries and/or subgrain boundaries of the reactant to facilitate its reaction with water. For example, a reactant may include aluminum combined with gallium and/or indium. In some instances, the activating composition may be an eutectic, or close to eutectic composition, including for example an eutectic composition of gallium and indium. In one such embodiment, the activating composition may comprise gallium and indium where the portion of the activating composition may have a composition of about 70 wt %-80 wt % gallium and 20 wt % to 30 wt % indium though other weight percentages are also possible. Without wishing to be bound by theory, gallium and/or indium may permeate through the one or more grain boundaries and/or subgrain boundaries of the reactant (e.g., metal). For instances, the activating composition may be incorporated into an alloy with the reactant (e.g., metals such as aluminum). A metal alloy may comprise any activating composition in any of a variety of suitable amounts. In some embodiments, for example, the metal alloy comprises greater than or equal to 0.1 wt. % of the activating composition, greater than or equal to 1 wt. %, greater than or equal to 5 wt. %, greater than or equal to 15 wt. %, greater than or equal to 30 wt. %, or greater than or equal to 45 wt. % of the activating composition based on the total weight of the metal alloy. In certain embodiments, the metal alloy comprises less than or equal to 50 wt. %, less than or equal to 40 wt. %, less than or equal to 30 wt. %, less than or equal to 20 wt. %, less than or equal to 10 wt. %, less than or equal to 5 wt. %, or less than or equal to 1 wt. % of the activating composition, based on the total weight of the metal alloy. Combinations of the above recited ranges are also possible (e.g., the metal alloy comprises greater than or equal to 0.1 wt. % and less than or equal to 50 wt. % of the activating composition based on the total weight of the metal alloy, the metal alloy comprises greater than or equal to 1 wt. % and less than or equal to 10 wt. % of the activating composition based on the total weight of metal alloy). Other ranges are also possible.

In some embodiments, the shape and/or size of the reactant may be tailored to a size suitable for the specific application using methods understood to a person of ordinary skill in art. For instance, steam generation may be optimized by maximizing the availability of surface contact between the water and reactant. As such, the shape and size of the reactant may be chosen to optimize the surface contact with water. For example, in some embodiments, the size of the reactant may be altered using milling and/or jet cutting, laser cutting, and/or any other appropriate manufacturing method. Additionally, the reactant may have any appropriate physical form including plates, pellets, powders, blocks, and/or any other form as the disclosure is not limited in this fashion.

In some embodiments, the reactant may be solid. The solid reactant may be provided in discrete pieces, such as pellets. The pellets may be regularly shaped, such as spherical, or may be irregularly shaped chunks. The size of the pellets may be uniform or varied. Alternatively, the solid reactant may be provided in a more continuous form, such as a powder with any appropriate size distribution for a desired application. Of course, a combination of pellets and powder may also be used and/or different forms of a solid reactant may be used, as the disclosure is not limited in this regard. Without wishing to be bound by theory, the size of the individual elements may influence the operation of the system. For example, smaller individual pieces of reactant may have a larger surface area for a given total volume, yielding a faster reaction when combined with water. As such, a powder may be desirable over a pellet form of reactant in some applications when a faster reaction is desired.

In some embodiments, a reactant may be provided in the form of a slurry that combines the reactant material with a non-reactive liquid carrier. For example, a slurry may include particles of the reactant material suspended in an inert fluid. In some embodiments, the fluid may be an oil, such as mineral oil, canola oil, or olive oil. In other embodiments, the fluid may be a grease, alcohol, or other appropriate material capable of suspending the reactant material in solution. In some embodiments, the diameter of the particles in the slurry may be between approximately 10 micrometers to 200 micrometers, 10 micrometers to 50 micrometers, and/or any other appropriate size range depending on the particular embodiment. In one embodiment, a slurry may be produced in a colloid mill, although other methods of producing a slurry are also contemplated as the disclosure is not limited in this regard.

It should be understood that a slurry may have any appropriate ratio of the reactant to fluid carrier by weight. Further, without wishing to be bound by theory, the ratio of the reactant material to fluid carrier in the slurry may affect both the physical properties of the slurry as well as the performance of the system. For example, a slurry that has a reactant/carrier ratio of 90:10 by weight may be characterized as a paste, whereas a slurry with a 50:50 ratio may flow more easily. In some applications, a reactant/carrier ratio as low as 10:90 may be desirable. Accordingly, a ratio of a reactant to fluid carrier by weight may be between about 10:90 and 90:10, though other appropriate ranges both greater and less than those noted above are also contemplated.

Certain embodiments comprise flowing hydrogen gas and the steam generated from reaction (1) into a balloon to increase a buoyancy of the balloon. In some cases, a total amount of hydrogen gas and steam may be generated to fill or inflate the balloon within a desired time frame. For instance, aforementioned mentioned parameters (e.g., water to reactant ratio, react composition, etc.) may be configured to generate sufficient hydrogen gas and steam to inflate a balloon in less than or equal to 10 minutes, less than or equal to 8 minutes, less than or equal to 5 minutes. In some such embodiments, the mixed gas may be produced and/or filled at a volumetric flowrate of greater than or equal to 2,000 L/min, greater than or equal to 5,000 L/min, greater than or equal to 8,000 L/min. In some embodiments, the hydrogen gas may be produced and/or filled at a volumetric flowrate of less than or equal to 10,000 L/min, or less than or equal to 7,000 L/min, or less than or equal to 4,000 L/min. Of course, any suitable rate of mixed gas generation may be used depending on the desired application. For instance, a desired rate of steam generation may be achieved by optimizing the aforementioned parameters (e.g., water to reactant ratio, reactant composition, available surface area of reactant to contact water, etc.).

Certain embodiments are related to a system for producing hydrogen gas and steam. In some embodiments, the system comprises a reactor chamber configured to contain a reactant. In some cases, a reactant feeder configured to selectively provide the reactant, e.g., at a desired flowrate and/or amount, from a reactant reservoir to the reactor chamber may be used in some embodiments. Additionally, a water reservoir may be operatively coupled to the reactor chamber and a water feeder may be configured to selectively provide water from the water reservoir to the reactor chamber. In some cases, the water feeder and/or the reactant feeder may be configured to provide an optimized amount of water and reactant (at a water to reactant ratio disclosed herein) to the reactor chamber, such that a mixture of hydrogen gas and steam may be generated. Any suitable water to reactant ratio disclosed herein may be used.

In some embodiments, the system for producing hydrogen gas and steam is configured to operate on the ground. For instance, the system may be used to provide a balloon with an initial supply of hydrogen gas and steam to increase a buoyancy of the balloon. The system may be disconnected from the balloon as the balloon is ready for take-off. In other embodiments, the system is integrated into a balloon payload to form a balloon system. In some such embodiments, the system is connected to the balloon at all times (e.g., take off, in flight, etc.) and is configured to supply the balloon with an on-demand flow of hydrogen gas and steam.

According to some embodiments, the use of chemical reaction (e.g., reaction (1)) in a balloon system may enable on-demand production of both hydrogen gas and steam. Compared to conventional systems that may carry large and/or heavy tanks for hydrogen storage, on-demand hydrogen and steam production may only carry the reactant, the water, and hardware associated with harnessing the reaction. Consequently, a balloon may be able to devote less of its payload to hydrogen and steam storage, creating space within the payload for additional sensors, communication devices, and/or other appropriate equipment. Additionally, less weight associated with hydrogen storage may enable longer flights.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

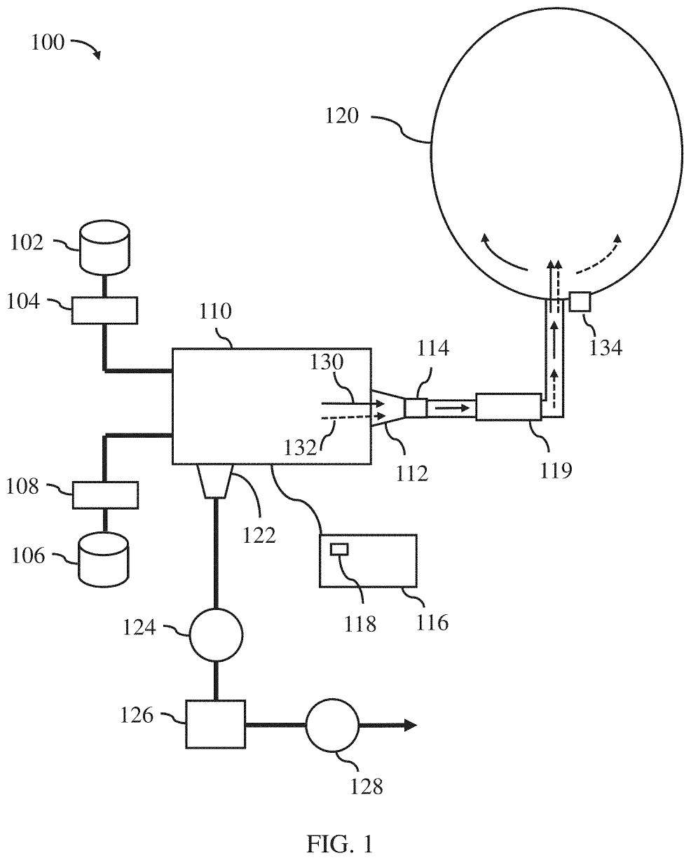

FIG. 1 is a schematic representation of one embodiment of a balloon system 100. In this embodiment, a reactor chamber 110 is operatively coupled to a balloon 120. A reactant reservoir 102 and a water reservoir 106 are operatively coupled to the reactor chamber 110. Components that are operatively coupled may refer to components that are connected (e.g., fluidically connected and/or electrically connected) to each other during operation or while in use. As shown in FIG. 1, the reactant reservoir 102 may be fluidically connected to a first reactor inlet on a first side of the reactor chamber 110, and the water reservoir 106 may be fluidically connected to a second reactor inlet on the first side of the reactor chamber 110. In some embodiments, a reactant reservoir feeder 104 and/or water reservoir feeder 108, which are described in more detail below, may be disposed along the flow path (e.g., pipes, tubes, direct connections, and/or any other appropriate type of fluid connection) extending between the respective reservoirs and the reactor chamber. The reactor chamber 110 may have a reactor outlet 112 on a second portion of the reactor chamber 110 that is fluidically connected to an inlet of the balloon 120. As described in more detail, a regulator 114 and/or an outlet flow control 119 may be disposed along the flow path fluidly connecting the reaction chamber 110 and the balloon 120.

The reactor chamber 110 may include a waste outlet 122 located on a third portion of the reaction chamber that is fluidically connected to a waste container 126. The waste container 126 may have an outlet fluidically connected to an external environment. Optional pumps (e.g., a first pump 124, a second pump 128) may be present along the flow path extending between the reactor chamber and the waste container and/or between the waste container and the external environment. As described in more detail below, one or more a processor 116 and one or more sensors 118 may be operatively associated with the reaction chamber 110 and/or one or more components of the reaction chamber. While FIG. 1 shows one non-limiting example of an arrangement of the relative components within the balloon system, it should be noted that other arrangements are also possible. For example, each of the associated components (e.g., reactant reservoir, water, reservoir, balloon, processor, waste container, etc.) may be operatively coupled to the reaction chamber at any appropriate location on the reaction chamber, as long as each serves its intended purposes without compromising the functions and properties of the other components.

When the reactant is combined with the water in the reactor chamber 110, a reaction produces hydrogen gas and steam. For example, in embodiments in which the reactant is aluminum or an alloy of aluminum with an activating composition, hydrogen gas may be produced according to Eq. (1), as described above. In some embodiments, and as discussed above, steam may be generated from the heat of reaction from reaction (1). The generated heat may be sufficiently large relative to the water volume within the reaction chamber that at least a portion of the water is vaporized to form steam. The hydrogen gas 130 and steam 132 exit the reactor chamber 110 through an outlet 112. Hydrogen gas 130 and steam 132 produced in the reactor chamber 110 flows through the outlet 112 and into the balloon 120.

It should be noted that the balloon system 100 may be either a temporary or permanent system, depending on the application. For instance, according to some embodiments, the system for producing hydrogen gas and steam is configured to operate on the ground. In some such embodiments, the reactor chamber provides an initial mixture of gas to the balloon and is only temporarily attached to the balloon. For instance, a reaction chamber 110 disclosed herein may be initially connected to a balloon 120 (forming balloon system 100) during the filling process until the balloon is filled with a predetermined amount of hydrogen gas and steam. The reaction chamber 110 may then be disconnected from the balloon 120 as the balloon is ready for take-off. In some such embodiments, altitude control of the balloon 120 may be associated with using the water condensate condensed from at least a portion of the steam 132 as a ballast, as described below.

According to some embodiments, the balloon system 100 may stay intact permanently as an integrated system, both during lift-off and while in-flight. For instance, the system for producing hydrogen gas and steam may be integrated with a balloon payload, forming the balloon system 100. In some such embodiments, the system may be configured to supply the balloon with an on-demand flow of steam and hydrogen gas, in response to an altitude change associated with the balloon system.

The reactor chamber 110 may be any appropriate reactor. For example, the reactor chamber may be a stir bar reactor, a vibration reactor, a bed reactor, and/or any other appropriate reactor. In some embodiments, the reactor chamber is a continuously stirred tank reactor. High-altitude balloons may operate in cold environments in which a reactor chamber may become cold. A cold reactor chamber may limit the efficacy of the reaction. As such, in some embodiments, the reactor chamber may include heaters, insulation, or other protection against cold. Heaters may include excess heat from an associated processing unit, waste heat from other components of the balloon system, electrical resistance heaters, furnaces, or any other suitable device for providing heat. Some reactions that may be appropriate for use in high-altitude balloon systems may be temperature dependent. As such, the reactor chamber may be intentionally kept at a temperature below a first threshold temperature to avoid thermal runaway and above a second threshold temperature that is less than the first threshold temperature to maintain the reactant and/or water at a desired temperature for the reaction. Accordingly, in some embodiments, the relatively cold environment encountered during high altitude flight may be beneficial, and may be purposefully used to regulate the temperature of the reactor chamber. In some embodiments, the reactor chamber temperature may be actively cooled and/or heated to control a temperature in the reactor through: control of the amount of reactant and/or the amount of water introduced to the reactor chamber; passive cooling with the environment such as by including heat sinks; transfer of heat with other systems via heat pipes or other heat transfer systems; electrical heaters and other types of heaters; the use of waste heat from other system components; and/or through the use of any other components or features capable of transferring heat to or from the reactor chamber to provide a desired operating temperature.

In some embodiments, the depicted system may include a regulator 114 coupled to the outlet 112 of the reactor chamber 110. The regulator 114 may be disposed at any appropriate location along the flow path extending between the reaction chamber and the balloon. For example, the regulator may be disposed on or adjacent to the reactor outlet 112 along the flow path connection. The regulator 114 may be configured to regulate the outlet pressure and/or flow rate of the mixed gas produced in the reactor chamber 110 through the outlet. The presence of a regulator may allow precise control of the pressure and/or amount of mixed gas within the balloon at a given time, such that overinflation of the balloon may be prevented and the lifting force of the balloon at a given time may be controlled. In some embodiments, a reactor chamber may have multiple outlets with multiple associated regulators. Further, in some applications, the one or more outlets may not be regulated at all. In some embodiments, a regulator may be a pressure regulator, a flow regulator, a regulator that regulates both pressure and flow, and/or any other suitable type of regulator as the disclosure is not limited in this regard.

In some embodiments, the balloon system described herein may advantageously include a flow control capable of controlling the flow rate and/or amount of mixed gas that flows into the balloon from the reaction chamber. The rate and/or amount of mixed gas may be directly related to the lifting force of the balloon at a given time. Accordingly, such a flow control may advantageously allow for altitude control of the balloon system at a given time. In some embodiments, an outlet flow control 119 may be fluidically connected to the reactor chamber 110 and balloon 120, such that the outlet flow control 119 controls the flow of the hydrogen gas and steam from the reactor chamber to the balloon 120. The outlet flow control 119 may be located at any appropriate location along the flow path extending between the outlet 112 of the reactor chamber 110 and the inlet of the balloon 120. In some cases, the outlet flow control 119 may be located at a region along the flow path connection between the regulator 114 and the inlet of the balloon 120. The outlet flow control 119 may be a valve, a pump, or any other suitable mechanism configured to selectively control delivery and/or flow of a material. For example, the outlet flow control 119 may be a gate valve, a ball valve, a butterfly valve, or any other suitable valve that can control the flow of hydrogen gas and steam from the reactor chamber 110 to the balloon 120. When the outlet flow control 119 is open or otherwise operated to permit the flow of gas, hydrogen gas and steam (which may be regulated by regulator 114) may flow from the reactor chamber 110, through the outlet 112, and to the balloon 120. When the outlet flow control 119 is closed or otherwise operated to prevent the flow of gas, hydrogen gas and/or steam may be prevented from flowing into the balloon 120.

The embodiment of FIG. 1 additionally includes one or more sensors 118 configured to sense one or more parameters of the reaction. In some cases, the one or more sensors may be disposed in any appropriate locations in the balloon system, such as within the reactor chamber and/or along any appropriate flow path connections (e.g., between the reactor chamber and the balloon, between the reservoirs and the reaction chamber, etc.). Non-limiting examples of the one or more parameters include temperature and/or pressure within the reactor, and/or the amount of one or more substances (e.g., water, reactant, mixed gas, etc.) within the reactor. In some embodiments, a processor 116 may be operatively coupled (e.g., electrically connected) to the one or more sensors 118 and other components of the system such as the flow control 119 and/or other components of the system for controlling the flow of gas and/or the amount of water and/or reactant feed into the reactor chamber. In one set of embodiments, the one or more sensors 118 may be electrically connected to the reactant chamber 110 and configured to sense a relative amount of water and/or reactant within the reactant chamber. For example, using information from the sensors, the processor 116 may control the amount of water and/or the amount of reactant that are provided to the reactor chamber, e.g., by controlling the reactant reservoir feeder 104 and/or water reservoir feeder 108. In one such embodiment, the one or more sensors 118 may sense a temperature and/or pressure of the reactor chamber 110. If the sensors sense that the temperature and/or pressure of the reactor chamber 110 is above a predetermined threshold, the processor 116 may generate commands to limit the amount of reactant and/or water provided to the reactor chamber in order to reduce the rate of reaction. Such feedback control may allow the system 100 to operate stably. Of course, feedback may be performed on parameters different than temperature. Alternatively or additionally, in cases where the pressure of the reactor chamber is above a predetermined threshold pressure (e.g., as a result of mixed gas buildup), the processor 116 may generate commands to release the pressure (e.g., mixed gas) by allowing the mixed gas to flow from the reaction chamber 110 to the balloon 120. The processor may communicate with the pressure regulator 114 and/or the outlet flow control 119 to control the flow of the mixed gas. The one or more sensors may include temperature sensors, pressure sensors, chemical sensors, light sensors, acoustic sensors, force sensors, strain sensors, accelerometers, gyroscopes, or any other suitable sensors. In some embodiments, the system may additionally include a memory associated with the processor. The memory may include instructions that when executed by the processor perform the methods described herein. Of course, it should be understood that while embodiments related to the use of sensors have been described, embodiments in which sensors are not used are also contemplated. Additionally, in some embodiments, a reactor may include multiple processors, and the processors may control multiple aspects of the system.

As mentioned, according to some embodiments, the reactant feeder and the water feeder are configured to provide a desired ratio of water to reactant to the reactor chamber to generate hydrogen gas and steam. For example, in the embodiment of FIG. 1, the processor 116 may control an amount of reactant provided to the reactor chamber 110 using a reactant feeder, such as a reactant reservoir valve 104 that is positioned downstream from an outlet of the reactant reservoir. In such an embodiment, the reactant reservoir valve 104 may be a gate valve, a ball valve, a butterfly valve, or any other suitable valve that may be selectively opened or closed to control the flow of reactant from the reactant reservoir 102 to the reactor chamber 110. Though embodiments in which a reactant is already present within a reaction chamber and a reactant feeder is not used are also contemplated. Similarly, in the embodiment of FIG. 1, the processor 116 may control the amount of water provided to the reactor chamber 110 using a water reservoir valve 108 or other appropriate type of water feeder. The water reservoir valve 108 may be a gate valve, a ball valve, a butterfly valve, or any other suitable valve connected to and located downstream from an outlet of the water reservoir such that the valve may control the flow of water from the water reservoir 106 to the reactor chamber 110. Though embodiments in which water is already present within a reaction chamber and a water feeder is not used are also contemplated. In other embodiments, a flow control may be used instead of either a reactant reservoir valve and/or a water reservoir valve.

While reactant and water feeders corresponding to valved controls are noted above, it should be understood that these feeders are not limited to only valved systems. Instead, any appropriate type of feeder capable of transporting water and/or reactant from a corresponding reservoir to the reactor chamber may be used. Appropriate types of feeder systems may include, but are not limited to, a pump, a belt feeder, a scoop feeder, a screw feeder, and/or any other appropriate type of construction capable of transporting a desired amount of material from the associated reservoir to the reactor chamber depending on the form of the reactant and/or water (e.g., slurry, fluid, solid, etc.). In such embodiments, the reactant and/or water may be pumped into the reactor chamber using one or more pumps. For example, a reactant in the form of a slurry may be urged through one or more valves and/or into the reactor chamber by using a pump. In other embodiments, pumping may not be used to transmit either the reactant or the water. For example, solid reactant in the form of pellets or powder may be transmitted to the reactor chamber by means of gravity. In such an embodiment, the reactant reservoir may be a hopper suspended above the reactor chamber. The hopper may include a valve or other structure constructed to selectively permit or prevent the transmission of reactant to the reactor chamber. The reactant may be urged to exit the hopper by means of vibration or an auger mechanism.

It should be noted that in certain cases, it may be advantageous to introduce water into the reaction chamber via a water feeder such as a sprinkler, a spray nozzle, or other appropriate structure capable of spraying or otherwise introducing water droplets into the reaction chamber that may then come into contact with the surfaces of the reactants. As such, the surface contact between the water droplets and reactant may be increased and the rate of steam generation may be optimized.

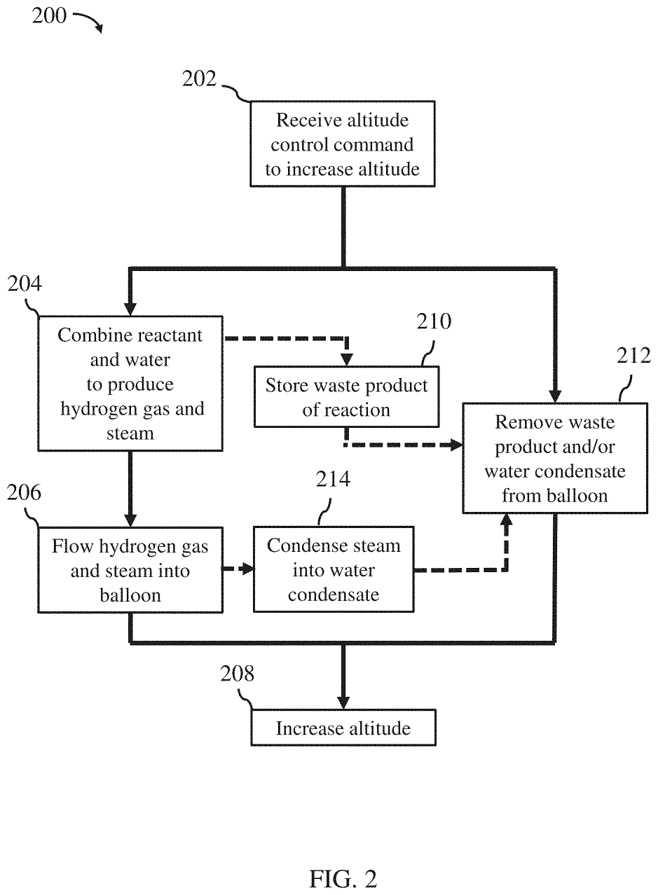

In some embodiments, the processor 116 may control the amount of reactant and/or water provided to the reactor chamber 110 based on signals received from the one or more sensors 118 which may be configured to sense one more operating parameters associated with the reactor chamber and/or other portions of the system. Alternatively, a signal from an internal system of the balloon and/or a remotely located control system may command the processor to control the system to generate gas and steam for controlling an altitude of the balloon as detailed in further below in FIG. 2. In one specific embodiment, if the sensors sense that the temperature of the reactor chamber 110 is above a predetermined threshold temperature, the processor 116 may control one or more of the water and/or reactant feeders to limit the amount of water and/or reactant provided to the reactor chamber. The sensors 118 may be configured to sense other relevant parameters of the reactor chamber beyond temperature. For example, the sensors may be configured to sense the pressure of the reactor chamber, a flow rate of gas from the reactor chamber to the balloon, and/or any other appropriate operating parameter using any appropriate type of sensor as the disclosure is not limited in this fashion. For example, if a pressure and/or flow rate of the gas is below a predetermined threshold pressure and/or flow rate, the processor may control the feeder systems to add additional reactant and/or water to the reactor chamber to increase the production of gas.

In some embodiments, the reactor chamber may have multiple outlets. For example, in addition to an outlet that may allow the produced hydrogen gas and steam to exit the reactor chamber, the system 100 may include a waste outlet 122 formed in the reactor chamber that may be distinct from the hydrogen gas and steam outlet 112. In embodiments in which the reactant is aluminum, combining the reactant with the water may produce aluminum hydroxide in addition to producing hydrogen gas and steam, as described in Eq. (1). The produced aluminum hydroxide may be considered a waste product.

In some embodiments, the produced waste may be removed from the system to decrease weight, thereby allowing the balloon system to increase altitude. The waste product may be actively discharged from the reactor chamber 110 with one or more pumps or any other appropriate type of feeder handling system for removing the waste product from the reactor chamber. As shown in FIG. 1, the waste container 126 may be fluidically connected to a waste outlet 122 located on the reaction chamber 110 via a first pump 124. The waste container 126 may be further fluidically connected to an external environment via a second pump 128. For example, the first pump 124 may urge the waste from the reactor chamber 110 through the waste outlet 122 and into the waste container 126. When a command to increase altitude is received, the waste container may be at least partially emptied using the second pump 128 that may remove waste from the waste container, and thus, removing a desired amount of the waste material from the system 100 entirely such that it may act as dropping ballast from the system. The pumps may be controlled by the processor 116. Additional sensors may sense parameters related to waste removal, such as operation of the pumps and/or the remaining capacity of the waste container 126. In some embodiments, the waste product may be removed through alternative mechanisms. The waste product may be released in a controlled manner through a device such as an auger, a scooper, belt feed, or any other appropriate mechanism. By controlling the amount of waste material released from the balloon system, the amount of weight lost can be controlled, thereby altering the balance of forces on the balloon. If all other forces remain constant, decreasing the weight of the balloon system may cause the balloon system to rise or stop descending. In some embodiments, the waste product may be wet. In such embodiments, it may be desirable to warm the waste product to prevent the waste product from freezing using methods and systems similar to those described above for controlling a temperature of the reactor chamber and overall system.

In some embodiments, the steam within the balloon may be advantageously used as a ballast for altitude control. For instance, as mentioned above, at least a portion of the steam may condense into a water condensate as a result of conductive and/or convective heat transfer across the balloon or other heat transfer structure. As a result, the lifting capability of the gases inside the balloon may decrease and the balloon may experience a decrease in altitude as the steam condenses and flows into a bottom portion of the balloon relative to a local direction of gravity. As such, the water condensate may function as a ballast, where at least a portion of the water condensate from the balloon may be removed to an external environment via a vent disposed on a bottom portion of the balloon that may either be directly vented to the external environment or may be in fluid communication with a waste storage tank and/or waste outlet of the system where the condensed water may either be dumped immediately and/or at some other appropriate time. In one such embodiments, a vent may be in fluid communication with an interior of the balloon and configured to remove at least a portion of the water condensate from the balloon to an external environment. For example, according with some embodiments, the system 100 comprises a vent 134 disposed at a location on a bottom portion of the balloon. In some cases, the vent may be located at a bottom portion of the balloon that is adjacent (or in close proximity to) the bottom most point of the balloon when the balloon is in an inflated configuration (as shown in FIG. 1). In some instances, an inflated balloon may have a height H and width W (where H and W may be the same or different), and the vent may be located at a bottom portion of the balloon that is up to 30% (e.g., up to 20%, up to 15%, up to 10%, up to 5%, up to 2%, or up to 1%, etc.) of a height H or a width W away from the bottom most point of the balloon relative to a direction of gravity when the balloon is inflated with a buoyant gas relative to a surrounding environment. In some cases, the bottom most point of the balloon may be located at the opening the balloon, e.g., such as the inlet through which mixed gas (e.g., hydrogen and/or steam) enters into the balloon. Though, it should be noted that the vent may be located in any suitable location on the balloon, as long as the water condensate can be accumulated at or directed to said location. In some embodiments, water condensate may flow across the interior walls of the balloon in the direction of gravity towards the vent.

Any suitable mechanisms may be employed to remove the water condensate from the inside of the balloon. For instance, in some instance, the balloon may comprise a hydrophobic inner wall or regions of inner wall with hydrophobic coatings that are in direct contact with the steam. The hydrophobic nature of the inner wall may induce a rapid flow of condensate towards a bottom portion of the balloon which may help avoid the formation and retention of condensates on the inner wall of the balloon. For instance, upon formation of water condensate on the hydrophobic inner wall, gravity may induce a flow of water condensates to a location adjacent a vent disposed on the balloon. In some cases, the vent may comprise a valve selected from the group of float valves, gate valve, butterfly valve, or any other suitable valve, such that a portion of the water condensate may be selectively drained from within the balloon through the valve while retaining the hydrogen within the balloon.

In some embodiments, the vent (e.g., valve) may be operated and/or actuated based on a sensed parameter associated with the condensate. For instance, nonlimiting examples of the parameter may include water level, conductance between two electrodes, and/or any other appropriate parameter. In some instances, a conductance sensor comprising electrodes may be installed next to the valve, such that as the valve may open or close according to a change in conductance measurement as a result of the buildup of water condensate conducting current between the electrodes once a predetermined volume of water condensate has accumulated. Alternatively, optical sensors, pressure sensors, and/or any other appropriate sensor capable of sensing a parameter associated with the water condensate for operating a valve may be used. Alternatively, in other embodiments, passive actuation systems may be used including, for example, a float valve may be used such that when a sufficient volume of water condensate above a threshold volume is located in a portion of the balloon including the float valve, the float valve may open to permit the water condensate to be vented from the balloon and may close once the volume of water is below the threshold volume.

In some embodiments, a system for generating hydrogen gas may be reusable. For example, a reactant reservoir may be constructed such that it may be refilled after all of the reactant is consumed. Similarly, a water reservoir may be constructed such that it may be replenished after all of the water is consumed. For example, inlets into the reactant and/or water reservoirs may be used to add additional material to these reservoirs for further use. However, in other embodiments, the system may be designed for one-time use. In such embodiments, an appropriate amount and form of reactant and/or water may be provided to produce a desired amount of gas at a desired reaction rate.

FIG. 2 is a flow diagram of one embodiment of a method 200 for controlling an altitude of a balloon system (e.g., balloon system 100 in FIG. 1). For instance, FIG. 2 describes a system for producing hydrogen gas and steam that is integrated with a balloon payload, e.g., where balloon system 110 stays intact at all times (e.g., during take-off, while in-flight, etc.). At 202, an altitude control command to increase altitude is received. The altitude control command may be received by a transmitter after being sent by a remote operator, such as an operator on the ground, or the altitude control command may be generated onboard in response to, for example, various sensor readings. Controlling the altitude of the balloon may include increasing the buoyancy of the balloon, decreasing the weight of the balloon system, decreasing a buoyancy of the balloon (i.e. venting), and/or any appropriate combination of the forgoing. To increase the buoyancy of the balloon, hydrogen gas and steam may be flowed into the balloon. At 204, a reactant and water are combined to produce hydrogen gas and steam, as described above. At 206, the produced hydrogen gas and steam are flowed into the balloon from the reactor chamber. At 208, the altitude of the balloon is increased. To decrease the weight of the balloon system, a water condensate from steam and/or a waste product may be dropped as ballast. As described above, a water condensate may be formed as a result of the steam cooling down inside the balloon due to conductive/convective heat transfer across the membrane of the balloon. The water condensate collected inside of the balloon may be used as a ballast for altitude control. At 214, the water condensate inside the balloon may be released via a vent valve at the bottom of the balloon described herein. In addition, a waste product of reaction (e.g., aluminum hydroxide), may also be used as a ballast. For instance, as described above, during the reaction that occurs when the reactant and water are combined at 204, a waste product is produced. At 210, the waste product of the reaction may be stored in a waste container separate from a reactor chamber. At 212, at least a portion of the waste product is removed from the balloon system and dropped as ballast. In response, at 208, the altitude of the balloon is increased. In embodiments in which the reactant is aluminum, the waste product may be aluminum hydroxide.

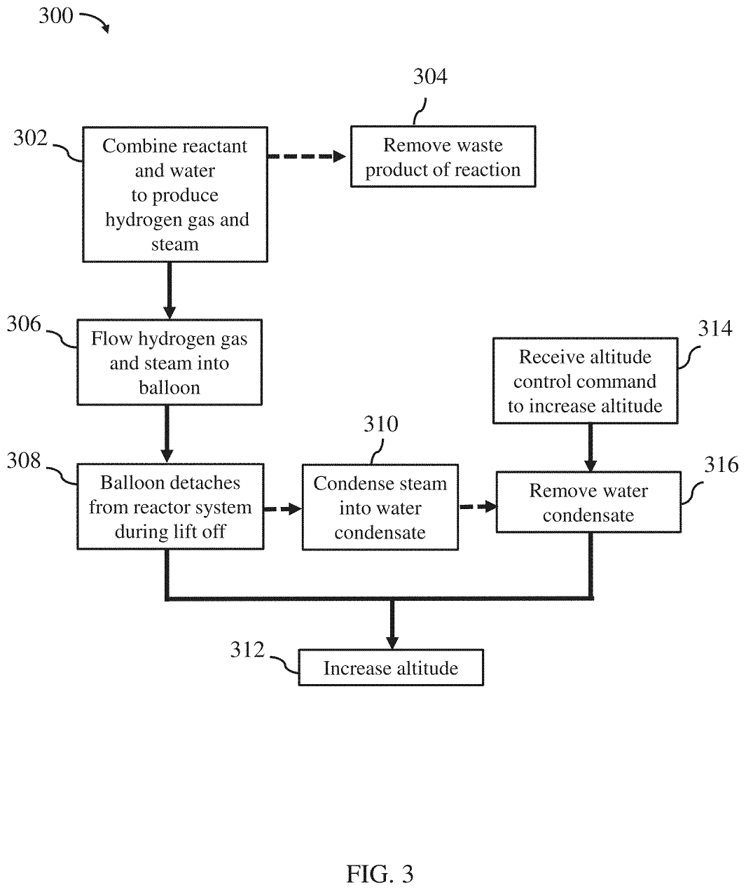

FIG. 3 is a flow diagram of one embodiment of a method 300 for controlling an altitude of a balloon that is not connected to any system for producing hydrogen gas and steam while in flight. For example, according to certain embodiments, a system for producing hydrogen gas and steam may be configured to operate on the ground and to supply a balloon with an initial lift force. In other words, the system for producing hydrogen gas and steam may be designed for one-time use. For instance, FIG. 3 describes altitude control for a system for producing hydrogen gas and steam that is only connected to a balloon before the balloon takes off. As shown, at 302, a reactant and water may be combined in a reaction chamber to produce hydrogen gas and steam. At 306, the hydrogen gas and steam are flowed into the balloon to increase a buoyancy of the balloon. Meanwhile, waste products of reaction may be removed from the reactor (e.g., as shown in 304). At 308, as a sufficient amount of mixed gases is loaded into the balloon, the balloon is detached from system and increases in altitude, as shown in 312. As described above, as the balloon increases in altitude, water condensate may be formed as a result of the steam cooling down inside the balloon due to conductive/convective heat transfer across the membrane of the balloon, as shown in 310. As a portion of the steam condenses into water condensate, the balloon may experience a decrease in altitude. As such, a controller or sensor described herein may be used to issue an altitude control command to increase altitude, as shown in 314. To decrease the weight of the balloon, a water condensate condensed from a portion of the steam and/or a waste product may be dropped as ballast. For instance, as disclosed above, a valve based at least in part on a parameter associated with the condensate (e.g., water level, conductance, etc.) may be actuated to open and release the water condensate. At 316, the water condensate inside the balloon may be released via a vent valve at the bottom of the balloon described herein, thus resulting in an increase in altitude (e.g., as shown in 312).

### Example 1

High altitude balloons typically utilize helium as the primary lifting gas, but helium is scarce, challenging to contain and ship, and is costly. In remote areas, helium is impractical due to supply chain constraints. Another approach could be to leverage aluminum-water reactions that produce heat and hydrogen according to reaction 1 described herein, as reproduced below:

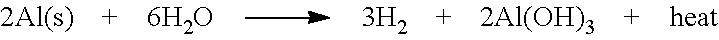

The aluminum-water reaction therefore produced two lifting gases simultaneously: hydrogen and steam generated from the heat of the reaction. Both hydrogen and steam could individually contribute to lift according to Table 1, which shows a comparison of required volumes and diameters of spheres with a lifting capacity of 1000 kg.

TABLE 1

| | Required | Required |
|---|---|---|
| | volumes of | diameters of |
| Gases | gases (m³) | spheres (m) |
| Hydrogen | 877 | 11.9 |
| Helium | 947 | 12.2 |
| Steam at 100° C. | 1567 | 14.4 |
| Hot air at 100° C. | 3633 | 19.1 |

According to the equation, 1 kg of aluminum reacting with 2 kg of water could contribute 1/9 kg of H₂ and 15MJ of heat. Since water vaporization would require 2250 kJ/kg, the steam generated by 1 kg of aluminum would be up to about 7 kg. Since steam has a volume of 1.65 m³ per kg at 100° C., steam could contribute 7.25 kg to the lifting capacity, while hydrogen could contribute 1.5 kg. Therefore, three kilograms of aluminum and water could generate up to 8.75 kg of total lift. The same lifting capacity using helium would require 8.25 m³, or about $15 worth of helium. Moreover, since the steam would condense as the balloon moved up in the atmosphere, there would be an opportunity to selectively remove the liquid water from the balloon, as needed, to act as ballast.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method of filling a balloon, the method comprising:
combining a reactant and water to produce hydrogen gas and steam; and
flowing the hydrogen gas and the steam into the balloon to increase a buoyancy of the balloon.

2. The method of claim 1, further comprising condensing at least a portion of the steam into water condensate.

3. The method of claim 2, further comprising removing at least a portion of the water condensate from the balloon to an external environment via a vent in fluid communication with an interior of the balloon.

4. The method of claim 3, wherein the vent comprises a float valve.

5. The method of claim 3, further comprising sensing a parameter associated with the water condensate and operating the vent based at least in part on the sensed parameter.

6. The method of claim 5, wherein the parameter is water level and/or conductance.

7. The method of claim 1, wherein the reactant includes at least one selected from the group of aluminum, lithium, sodium, magnesium, zinc, boron, and beryllium.

8. The method of claim 1, wherein the reactant comprises aluminum, gallium, and indium.

9. The method of claim 1, wherein the reactant is suspended in a fluid carrier selected from the group of oil, grease, alcohol, or combination thereof.

10. The method of claim 1, wherein the balloon comprises a hydrophobic material selected from the group of uncured latex, polyamide, and/or polydimethylsiloxane.

11. The method of claim 1, wherein the balloon comprises an inner wall or regions of inner wall having a hydrophobic coating.

12. A system for producing hydrogen gas and steam, the system comprising:
a reactor chamber, wherein the reactor chamber is configured to contain a reactant; and
a water reservoir operatively coupled to the reactor chamber, wherein a water feeder is configured to selectively provide water from the water reservoir to the reactor chamber, and
wherein the water reservoir is configured to provide a ratio of the water and the reactant in the reactor chamber to generate hydrogen gas and steam.

13. The system of claim 12, further comprising a reactant reservoir and a reactant feeder, wherein the reactant feeder is configured to selectively provide reactant from the reactant reservoir to the reactor chamber.

14. The system of claim 13, wherein the reactant feeder and the water feeder are configured to provide the ratio of water to reactant to the reactor chamber to generate the hydrogen gas and steam.

15. The system of claim 12, wherein the ratio of water to reactant is less than or equal to 28:1 by weight.

16. The system of claim 12, wherein the system is configured to operate on the ground.

17. The system of claim 12, wherein the system is integrated with a balloon payload.

18. The system of claim 12, wherein the reactant includes at least one selected from the group of aluminum, lithium, sodium, magnesium, zinc, boron, and beryllium.

19. The system of claim 12, wherein the reactant comprises aluminum, gallium, and indium.

20. The system of claim 12, wherein the reactant is suspended in a fluid carrier selected from the group of oil, grease, alcohol, or combination thereof.

21. The system of claim 17, wherein the system comprises a vent in fluid communication with an interior of the balloon payload configured to remove at least a portion of the water condensate from the balloon payload to an external environment.

22. The system of claim 21, wherein the system comprises one or more sensors configured to sense a parameter associated with the water condensate and operate the vent based at least in part on the sensed parameter.

23. The system of claim 22, wherein the parameter is water level and/or conductance.
